(19) United States
(12) Patent Application Publication
(10) Pub. No.: US 2024/0424515 A1
(43) Pub. Date: Dec. 26, 2024

(54) FLEXIBLE LINERS AND ASSEMBLIES FOR HIGH PRESSURE FLUID LINES

(71) Applicant: Precision Urethan & Machine, Inc., Hempstead, TX (US)

(72) Inventors: Daniel Fink, Porter, TX (US); Chris Flannagan, Cypress, TX (US); Oscar C. Duckworth, Sebastopol, CA (US)

(73) Assignee: Precision Urethane & Machine, Inc., Hempstead, TX (US)

(21) Appl. No.: 18/752,443

(22) Filed: Jun. 24, 2024

Related U.S. Application Data
(60) Provisional application No. 63/522,516, filed on Jun. 22, 2023.

(51) Int. Cl. B05B 15/18; F16L 57/06; F16L 58/10

(52) U.S. Cl. CPC B05B 15/18; F16L 57/06; F16L 58/1018

(57) ABSTRACT

Wear liners positionable within high-pressure flow lines that provide flow of particulate laden fluids. The wear liners decrease erosion in the flow lines from the particulates sliding and impact wear, and from irregular flow patterns. The wear liners may include internal supports that are partially or fully encased within the liner, such as adjacent one or both ends thereof. Assemblies that include the wear liners, and a gasket and retaining ring or a nozzle.

### CROSS-REFERENCE TO RELATED APPLICATIONS

The present application claims the benefit under 35 U.S.C. § 119(e) of prior U.S. Provisional Application Ser. No. 63/522,516, filed Jun. 22, 2023, the entire content of which is incorporated herein.

### FIELD OF THE INVENTION

The present invention is directed to wear liners having durable inserts configured to maintain integrity of the wear liners when used in high pressure flow lines, and more specifically to internally supported polymeric liners and assemblies that decrease erosion and corrosion in high pressure pipes that provide flow of particulate laden fluids.

### BACKGROUND

High pressure flow lines, such as those used in the oil and gas industries, are often exposed to fluids containing a range of materials, including sand and other particulates, which may erode, corrode, and otherwise cause damage to the flow lines and junctions between flow lines and/or other equipment. High pressure flow lines used in other industries, such as the flow lines carrying concrete/cement for shotcrete applications or abrasives for wet or dry sandblasting, are also susceptible to damage, particularly in any region experiencing a geometry change or transition, such as junctions between pipes or changes to the inner diameter.

High pressure flow lines used to transport fluids are also susceptible to erosion damage caused by fluid flow within the flow line. This erosion damage is due in part to irregular flow patterns, such as eddy currents, formed within the fluid when it enters or exits flow lines having different diameters or even minor obstructions. Irregular flow patterns can focus fluid flow at increased speed against specific locations within the flow line, thereby eroding the material of the flow line at those locations.

In the oil and gas industry, polymeric coatings have been developed to protect regions of the flow lines, such as at least the end regions or junctions between flow lines. When this layer becomes damaged, however, the entire pipe must be replaced. Replaceable polymeric inserts have also been developed to overcome this shortcoming. These inserts may fold or deform under high fluid pressures and not perform their intended function. Moreover, these inserts often include at least one face that is exposed to the particulate fluid, thus leading to damage to the insert. The insert may also be damaged during assembly or disassembly of the insert within a flow line union. In either case, the entire insert would need to be replaced.

### SUMMARY OF THE INVENTION

The present disclosure overcomes these shortcomings by providing wear liners that are positionable within flow lines, such as at any geometry change or transition of the flow line, and which are configured to decrease erosion and/or corrosion in the flow lines from particulates and/or irregular flow patterns. The flow lines may be any flow line carrying high erosion materials, such as abrasives, cement/concrete (e.g., as found in the high-pressure application of concrete/cement), slurries with debris, sand (e.g., as found in the high-pressure flow lines used in the oil and gas industry), and the like. Exemplary geometry changes and transitions include at least small to larger internal diameter, large to smaller internal diameter, tees, elbow, Y's, nozzles, restrictor plates, chokes, or other obstructions that change the speed or direction of the fluids or cause it to breakout or swirl.

Accordingly, the present disclosure provides wear liners and wear liner assemblies. Exemplary wear liners positionable at end regions or connection points of a flow line are configured to fit within a bore of the flow line and comprise a sleeve having a longitudinal bore therethrough and a radially extending rim at a first end thereof. The sleeve of the wear liners may be formed of a durable abrasion resistant material and may include one or more reinforcement inserts or alternative structural members to support the abrasion resistance material(s) of the sleeve. The reinforcement inserts or alternative structural members may be fully encased within the sleeve, or partially encased within the sleeve. Additionally, or alternatively, the sleeve of the wear liner may be adhered/bonded directly to the flow line.

A wear liner assembly may comprise a wear liner and, according to certain configurations, a liner seal positionable on the top side of the radially extending rim of the sleeve of the wear liner. A bottom side of the seal may be configured to interact with a lip on a top side of the radially extending rim of the sleeve to secure the seal to the sleeve. The wear liner assembly may further include a retaining ring secured to, or alternatively, positionable on a top side of the liner seal adjacent an outer circumference thereof, such as within a circumferential gap on the top side of the liner seal. The sleeve and liner seal cooperate to form a substantially smooth inner bore of the wear liner assembly.

The wear liner assembly may alternatively comprise a nozzle having first and second ends and a longitudinal bore therebetween. A first region of the longitudinal bore of the nozzle extending from a first end of the nozzle toward a midpoint of the nozzle has a first inner diameter that is sized and configured to provide attachment over an outer circumference of the flow line. A second region of the longitudinal bore of the nozzle extending from an end of the first region to a second end of the nozzle has a second inner diameter that is smaller than the first inner diameter but equal to, or substantially equal to, an internal diameter of a second end of the wear liner. The wear liner is configured to be received within an inner bore of the flow line and may be sized so that ends of the wear liner are substantially coincident with a first and second end of the flow line. The nozzle is configured to receive the second end of the flow line within the first region of the longitudinal bore. As such, the wear liner and the first region the nozzle, when attached to the flow line, cooperate to form a substantially smooth inner bore of the wear liner assembly.

The present disclosure also provides a wear liner assembly comprising the wear liner and a nozzle formed as a unitary construction. As such, the wear liner assembly may be positionable on the fluid line by sliding an end of the fluid line into the slot formed between the outer surface of the wear liner and the inner surface of the first end of the nozzle.

The present disclosure also provides any of the nozzles described herein in the absence of a wear liner.

The present disclosure also provides methods of use of the various wear liners, nozzles, and wear liner assemblies disclosed herein.

### BRIEF DESCRIPTION OF THE DRAWINGS

A better understanding of the present invention will be had upon reference to the following detailed description when read in conjunction with the accompanying drawings, wherein like numerals represent like features in the various views. It is to be noted that features and components in these drawings, illustrating views of embodiments of the present invention, unless stated to be otherwise, are not necessarily drawn to scale.

FIG. 1A illustrates a flexible wear liner assembly positioned within a flow line according to aspects of the present disclosure, wherein the flow line is shown as transparent.

FIG. 1B illustrates an enlarged view of section D of FIG. 1A.

FIG. 2A illustrates a cross-sectional view of the flow line shown in FIG. 1A, wherein a position of the flexible wear liner assembly within the flow line is depicted.

FIG. 2B illustrates a cross-sectional view of the flow line shown in FIG. 1A, wherein a position of a flexible wear liner assembly within the flow line is depicted.

FIG. 3 illustrates a top view of the flow line shown in FIG. 1A, wherein the flexible wear liner assembly within the flow line is apparent.

FIG. 4 illustrates a retaining ring of the wear liner assembly according to aspects of the present disclosure.

FIG. 5 illustrates a reinforcement insert of the end liner assembly according to aspects of the present disclosure.

FIG. 6 illustrates a wear liner and nozzle according to aspects of the present disclosure positioned within a flow line or attached to an end of the flow line, respectively.

FIG. 7 illustrates a cross-sectional view of the flow line of FIG. 6 showing a wear liner positioned therein and a nozzle attached to an end thereof.

FIG. 8 illustrates an enlarged view of section A of FIG. 7.

FIG. 9 illustrates a partial perspective view of the wear liner of FIG. 6.

FIG. 10 illustrates a side view of the wear liner of FIG. 6.

FIG. 11 illustrates a cross-sectional view along line 11-11 of the wear liner of FIG. 10 showing an alternate position of the reinforcement insert.

FIG. 12 illustrates a flow line having a nozzle according to aspects of the present disclosure attached to an end of the flow line.

FIG. 13 illustrates a cross-sectional view of the flow line of FIG. 11, showing a wear liner positioned therein and a nozzle attached to an end thereof.

FIGS. 14 and 15 are side and top views, respectively, of a nozzle according to aspects of the present disclosure.

### DETAILED DESCRIPTION OF THE INVENTION

The present invention relates to wear liners and assemblies including the wear liners that are designed to decrease erosion in high-pressure flow lines carrying particulate laden fluids. Prior to setting forth the aspects of the invention in greater detail, it may be helpful to an understanding thereof to set forth the following definitions of certain terms to be used hereinafter.

### Definitions and Abbreviations

Unless defined otherwise, all technical and scientific terms used herein have the same meanings as commonly understood by one of ordinary skill in the art.

As used in the specification including the appended claims, the singular forms “a,” “an,” and “the” include the plural, and reference to a particular numerical value includes at least that value, unless the context clearly dictates otherwise. For example, “an” insert, “a” clocking feature, or “the” gasket is a reference to one or more inserts, clocking features, or gaskets and equivalents thereof known to those skilled in the art, and so forth.

The use of “or” means “and/or” unless specifically stated otherwise.

As used herein, the term “substantially” may be taken to represent the inherent degree of uncertainty that may be attributed to any quantitative comparison, value, measurement, or other representation. Thus, the term substantially may mean an amount of generally at least about 80%, about 90%, about 95%, about 98%, or even about 99%. If referring to an alignment between two elements, for example, the term “substantially” may be referenced to an overall percentage of alignment. If referring to a measurement or a comparison between two elements, for example, the term “substantially” may be referenced to an overall percentage of measurement, i.e., substantially equal to may be about 80%, about 90%, about 95%, about 98%, or even about 99% the same as the referenced measurement.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

“Including” and like terms means including, but not limited to. When ranges are given, any endpoints of those ranges and/or numbers within those ranges can be combined within the scope of the present invention.

Various aspects of the inserts, liners, and assemblies detailed herein, and methods of use thereof disclosed herein have been illustrated with reference to one or more exemplary implementations or embodiments. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the words “comprising,” “including,” and “having” as used herein mean “including, but not limited to.”

The word “comprising” and forms of the word “comprising,” as used in the specification including the appended claims, does not limit the present invention to exclude any variants or additions. Additionally, although the present invention has been described in terms of “comprising,” the inserts, liners, assemblies, and methods detailed herein may also be described as consisting essentially of or consisting of. For example, while the invention has been described in terms of an assembly comprising a wear liner having a reinforcement insert, a liner seal, and a retaining ring, an assembly consisting essentially of or consisting of the same elements is also within the present scope. In this context, “consisting essentially of” means that any additional elements in the assembly or steps in the methods will not negatively or materially affect the durability or usefulness of the assembly, or the protection afforded to the flow line within which the assembly is positioned.

Various aspects of the inserts, liners, and assemblies detailed herein, and the method of use thereof disclosed herein have been illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled”, “directly attached,” and/or “directly joined” to another component, there are no intervening elements shown in said examples.

Relative terms such as “lower” or “bottom” and “upper” or “top” have been used herein to describe one element's relationship to another element illustrated in the drawings. It will be understood that relative terms are intended to encompass different orientations of aspects of the inserts, liners, and assemblies in addition to the orientation depicted in the drawings. By way of example, if aspects of the liner shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the orientation of the drawing.

In the following description, certain details are set forth to provide a better understanding of various embodiments of an interactive display surface. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

### Aspects of the Disclosure

The present disclosure provides wear liners configured to be positioned within transitions such as connection points and/or geometry changes in a high-pressure flow line. The wear liners may be part of an assembly that includes a fluid flow facing gasket or liner seal that may be replaced when damaged while the wear liner remains in position within the flow line. Such wear liners may be composed of a metal or durable polymeric material while the liner seal is generally composed of an elastomeric material. The wear liner and assembly comprising the same may decrease erosion and/or corrosion in the flow lines from particulates and/or irregular flow patterns. The wear liners may also be part of an assembly that includes a nozzle that is configured to reduce the risk of harm when aggregates in a fluid flow are expelled from the fluid line at high speed. When the wear liners are composed of a durable polymeric or elastomeric material, they may include internal supports, such as proximal to either end of the wear liner or along a longitudinal length thereof. Additionally, or alternatively, the polymeric or elastomeric wear liners may be adhered to or bonded to the flow line.

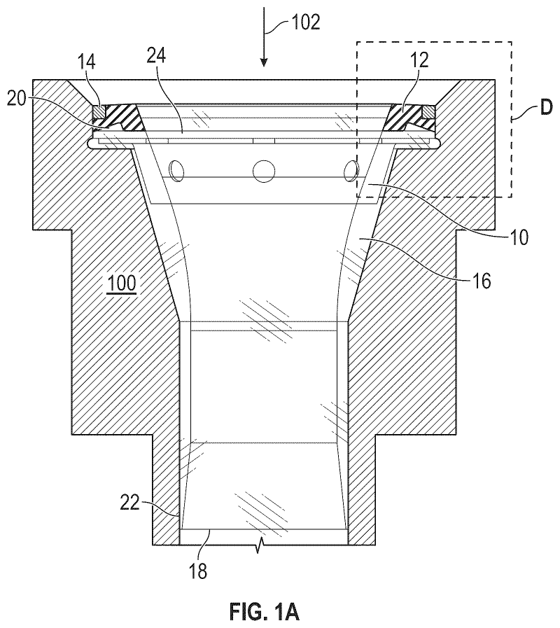

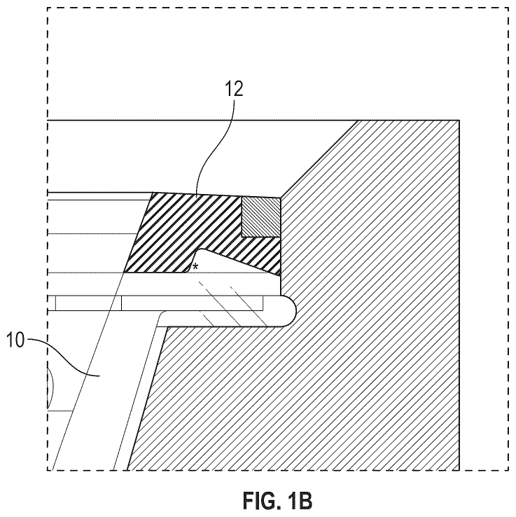

A first implementation of the wear liners and wear liner assemblies of the present disclosure will be described in more detail with reference to FIGS. 1A-5. With specific reference to FIG. 1A, a wear liner assembly is shown in partial cross section within a flow line 100. The assembly includes a wear liner having a sleeve 16 and a reinforcement insert 10. The sleeve 16 of the wear liner and the flow line 100 are illustrated as transparent so that the reinforcement insert 10 may be viewed. As shown, the sleeve 16 includes a first end 24 and a second end 18, and a longitudinal bore therebetween that provides for fluid flow 102. The first end 24 may include a radially extending rim having a lip 20 on a top surface thereof (i.e., axially extending protrusion). The first end 24 may be positioned at an end of the flow line 100 with the second end 18 downstream therefrom.

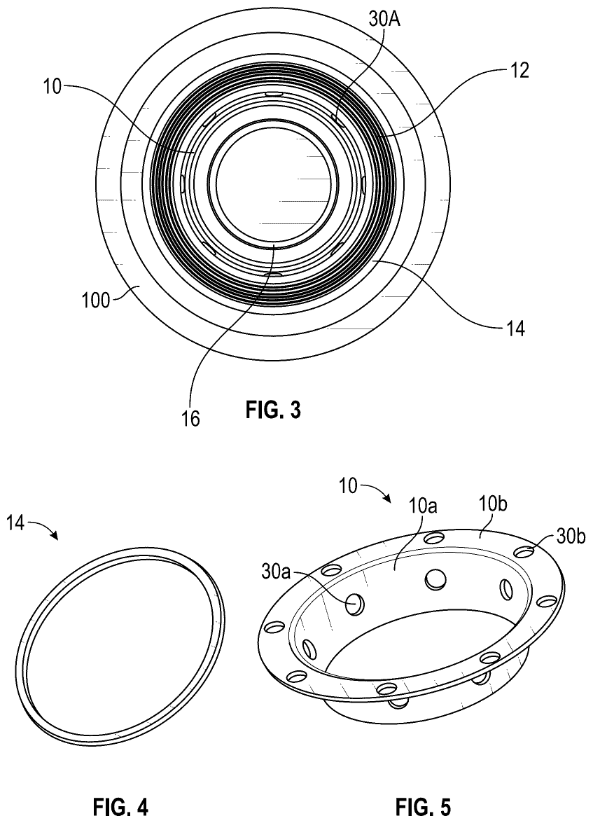

The reinforcement insert 10 may be positioned proximal to the first end 24 of the sleeve 16. With reference to FIG. 5, the reinforcement insert 10 may include a side wall 10a having a top rim 10b that extends radially therefrom. The top rim 10b and side wall 10 may be sized and configured to fit within the radially extending rim and first end 24 of the sleeve 16, respectively.

An outermost edge of the rim of the sleeve 16 may be sized and configured to fit within a gap on an inner surface of the flow line 100, thus helping to secure the sleeve within the flow line. As such, the top rim 10b of the insert 10 may be sized so that insertion or removal of the sleeve 16 from a flow line 100 may not be obstructed. For example, and with reference to FIGS. 1A and 5, the diameter of the top rim 10b of the insert 10 may be smaller than the diameter of the radially extending rim 13 of the sleeve 16 so that the outermost edge of the rim 13 may be inserted/removed from the gap on the inner surface of the flow line 100.

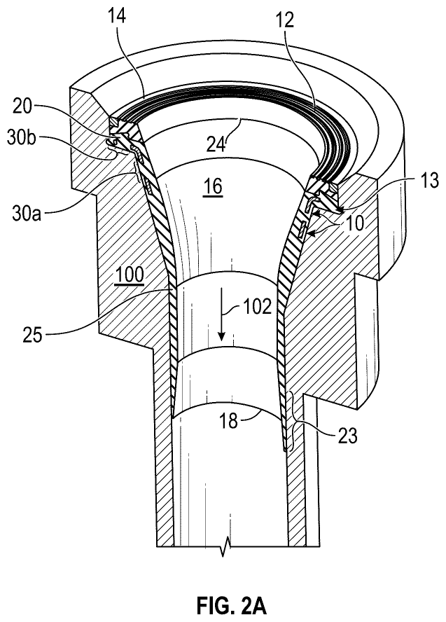

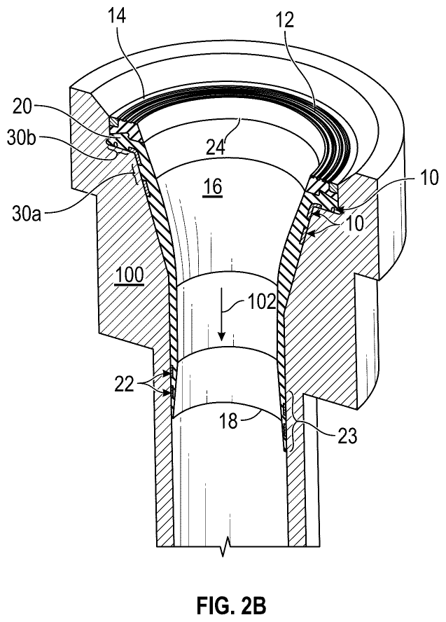

The sleeve may also include a second reinforcement insert positioned proximate to the second end 18 of the sleeve 16 (e.g., see cross sectional view of FIG. 2B, second reinforcement insert 22). Such an insert would be useful in the event of backflow within the flow line, or in flow lines that may experience bidirectional fluid flow. That is, should the direction of fluid flow 102 be reversed, the second end 18 of the sleeve 16 and a region 23 proximate thereto could roll inward and/or allow fluid into the space between the sleeve and the inner wall of the flow line 100, thus obstructing fluid flow.

While reinforcement inserts have been described as positioned proximate to either end of the sleeve, they may be positioned within the sleeve at any location. A position of the reinforcement inserts may be based on consideration of the loads and direction(s) of flow within the flow line. Moreover, while described above and shown in FIGS. 1-5 as cylindrical, the reinforcement inserts may have a shape coincident with the shape of the sleeve, which may be oval or any polygonal shape. For example, the reinforcement inserts may be non-cylindrical and may extend lengthwise along at least a portion of the longitudinal extent of the sleeve.

The reinforcement insert 10 may be completely encased within the sleeve 16, such as shown in FIG. 1A and the cross-sectional view of FIG. 2A, or an outer circumference thereof may be exposed while the remainder is encased within the sleeve 16, such as shown in the cross-sectional view of FIG. 2B. In this latter case, when the sleeve 16 is positioned within a flow line 100, the outer circumference of the insert 10 will be in contact with an inner wall of the flow line 100. When included, the second reinforcement insert 22 may be completely encased within the sleeve 16, or an outer circumference thereof may be exposed while the remainder is encased within the sleeve 16, such as shown in FIG. 2B. As with insert 10, when the sleeve 16 is positioned within a flow line 100, the outer circumference of the second reinforcement insert 22 will be in contact with an inner wall of the flow line 100.

The reinforcement insert 10 may comprise at least three apertures evenly spaced about a circumference thereof. For example, as shown in FIG. 5, the reinforcement insert 10 may include at least three apertures (30b) in the top rim 10b and at least three apertures (30a) in the side portion (side wall 10a). A second reinforcement insert 22, when included, would be cylindrical and could include at least three apertures evenly spaced circumferentially about a cylindrical wall thereof.

When forming the wear liner, the material of the sleeve 16, generally a polymeric material, will flow into the apertures of the reinforcement insert(s) to secure the insert(s) within the sleeve. Exemplary polymeric materials useful in forming the sleeve 16 include elastomeric polymers having a durometer of at least 50 A, such as at least 55 A, or 60 A, or 65 A, or 70 A, or 75 A, or 80 A, or 85 A, or 90 A, or 95 A, or about 100 A. Polymeric materials useful in forming the sleeve 16 further include those having a durometer of at least 10 D, such as at least 20 D, or 30 D, or 40 D, or 50 D, or 60 D, or even at least 70 D. Exemplary polymeric materials useful in forming the sleeve 16 include elastomeric polymers having a durometer of not more 70 A, or not more than 75 A, or 80 A, or 85 A, or 90 A, or 95 A, or 100 A. Polymeric materials useful in forming the sleeve 16 further include those having a durometer of not more than 10 D, such as not more than 20 D, or 30 D, or 40 D, or 50 D, or 60 D, or 70 D, or even 80 D. Any combination of upper and lower durometers from either scale (Shore A or Shore D) may be combined to define a range of durometers of the polymeric material of the sleeves disclosed herein. For example, the sleeve may be formed of a polymeric material having a durometer of 80 A to 100 A, or 65 A to 50 D, or 70 A to 60 D, and the like.

Exemplary polymeric materials include natural and synthetic rubbers, polyurethane, nylon, ethylene-vinyl acetate, polyetheretherketone, and fluoropolymers such as polytetrafluoroethylene. These polymers may be filled or non-filled, such as filled with carbon fiber, carbide, glass, ceramic, or glass ceramic. Preferred is polyurethane having a durometer of 80 A to 100 A.

The reinforcement insert(s) are composed of a stiffer material than the material of the sleeve 16. For example, the reinforcement insert(s) may be composed of a metal or a polymeric material having a higher durometer than the material of the sleeve, such as at least 80 A, or at least 90 A, or at least 100 A, or at least 30 D, or at least 40 D, or at least 50 D, or at least 60 D, or at least 70 D, or at least 80 D, or at least 90 D, or even 100 D, or not more than 100 D, such as less than 90 D, or less than 80 D, or less than 100 A. Any combination of upper and lower durometers from either scale (Shore A or Shore D) may be combined to define a range of durometers of the polymeric material of the reinforcement inserts disclosed herein. For example, the reinforcement inserts may be formed of a polymeric material having a durometer of 90 A to 100 A, or 65 A to 90 D, or 65 D to 100 D, and the like.

While the sleeve is described as including a reinforcement insert, sleeves absent such inserts are also possible and within the scope of the present disclosure. For example, the sleeve 16 could be formed of a metal or polymeric material having a durometer of at least 70 D, or 80 D, or 90 D, or even 100 D but not less than 60 D or not less than 100 A. Sleeves may be formed of a polymeric or elastomeric material comprising added materials to increase the load carrying capacity of the sleeves, such as glass, glass-ceramic, ceramic, and/or carbide, configured as fibers, particles, tubes, and the like.

Alternative to reinforcement inserts, or in addition thereto, the sleeve may be adhered or bonded to an inner surface of the flow line. In certain cases, the wear life of the sleeve may be extended significantly when adhered/bonded into the bore of the flow line: bonding may facilitate a corrosion resistant barrier to limit corrosion of the flow line allowing for less expensive material to be used in the application; and/or bonding may eliminate the need for supports as the flow line itself is used to restrict the liner from moving axially down the bore.

With reference to FIGS. 1A, 2A, and 4, the wear liner assembly may further include a liner seal 12 positionable on the top surface of the sleeve 16. The liner seal 12 may have a bottom surface configured to interact with the top surface of the sleeve 16 to secure the liner seal 12 thereon. The wear liner assembly may further include a retaining ring 14 positionable on a top side of the liner seal 12 adjacent an outer circumference thereof, such as within a circumferential gap on the top side of the liner seal 12. The retaining ring 14 may snap in place within the flow line to help secure the liner seal 12 therein. The retaining ring 14 may be attached to the liner seal 12 in situ, such as in-mold when the liner seal 12 is formed. The retaining ring 14 may be metal, or a polymeric material having a higher durometer than the liner seal 12. For example, the liner seal may be a flexible or elastomeric polymeric material having a durometer of at least 70 A, such as at least 75 A, or 80 A, or 85 A, or 90 A, or 95 A, or about 100 A and the retaining ring 14 may have a durometer of 70 D, or 80 D, or 90 D, or even 100 D. Exemplary materials for the liner seal are any of those disclosed hereinabove for the sleeve 16.

The lip 20 of the sleeve and the retaining ring 14 interact to keep the liner seal 12 from being deformed and/or dislodged under the forces of fluid flow. For example, and with respect to the orientation of the wear liner assembly and flow line 100 shown in FIGS. 1A and 3, fluid flow 102 will apply a downward force to the top surface of the liner seal 12 and an oblique force to the inner circumference of the liner seal. The lip 20 of the sleeve 16 will cooperate with a complementary surface on the bottom of the liner seal 12 to keep the liner seal 12 from being deformed and/or dislodged under the forces of fluid flow. According to certain aspects, the lip 20 of the sleeve 16 may include an indented region (region depicted by a ‘*’ in FIG. 1B would be indented) that provides an interference fit of the complementary region of the liner seal 12 to secure the liner seal 12 in position on the top surface of the sleeve 16 (see FIG. 1B).

The sleeve 16 and liner seal 12 cooperate to form a substantially smooth inner bore of the liner assembly, thus helping to reduce disrupted fluid flow in the flow line that may cause eddy currents. Moreover, a region 23 of the sleeve 16 proximate the second end 18 may taper to provide a reduced sleeve thickness at the second end thereof, such as shown in FIG. 2A.

The wear liner and wear liner assembly generally comprise an outer profile configured to provide a snug fit between an outer circumference thereof and an inner bore of the flow line 100 when positioned therein. For example, the sleeve 16 may have a funnel shaped top portion (region between 25 and 24; see FIG. 2A) and a cylindrical bottom portion (region between 25 and 18; see FIG. 2A). Such a shape may also protect the wear liner from being thrust down line under the pressure of a fluid flow in the lines. Reinforcement inserts designed and configured for the sleeve would therefore have complementary shapes. For example, and as shown in FIG. 5, the reinforcement insert 10 may have a funnel shaped side wall 10a. When included, the second reinforcement insert could be cylindrical.

Other geometries of the sleeve and/or reinforcement inserts may be useful and are within the scope of the wear liners of the present disclosure. For example, any change in geometry allowing for loading back to the internal diameter of the flow line is envisioned, such as groove(s) or ledge(s) machined into the flow line or any other restrictive geometry into which the wear liner may fit, and thus be held from moving axially down the flow line.

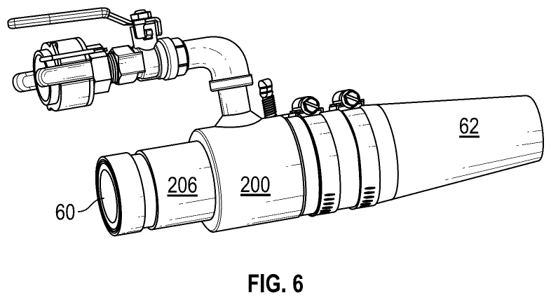

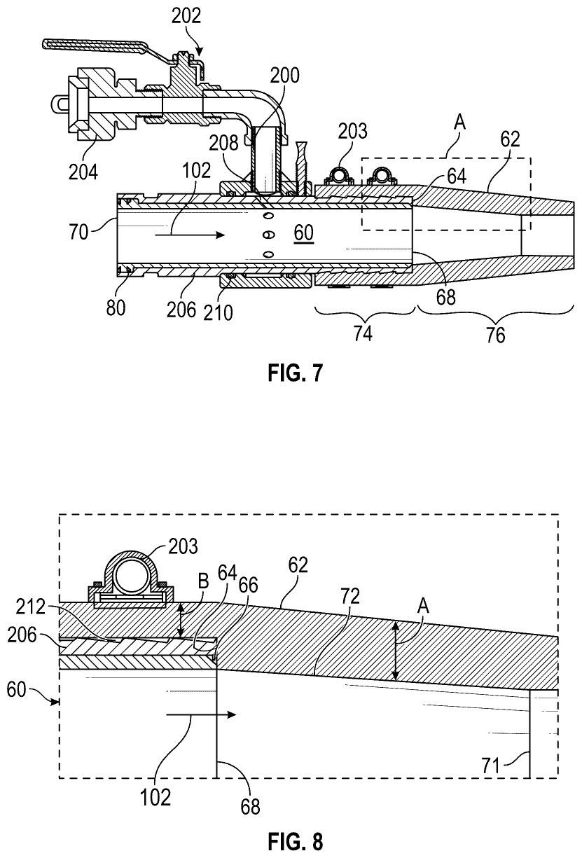

With reference to FIGS. 6 to 11, a wear liner and wear liner assembly according to various aspects of the present disclosure will be described. The wear liner is configured to be positioned within an inner bore of a flow line, such as a flow line 206 useful for connection with an air mixing housing 200. Such housings 200 find use in shotcrete applications, wherein an air valve 202 and inlet 204 for compressed air are attached to the housing 200. In this configuration, the flow line 206 may be carrying concrete/cement, which may be mixed with air via the air throttle ports 208 to expel the concrete/cement at high pressure through a nozzle 62. The wear liner includes a sleeve 60 having a longitudinal bore therethrough, a first end 70 having a radially extending rim 82 and a second end 68. The radially extending rim 82 may be sized and configured to be snugly accepted by a region of the flow line 206 having an expanded diameter, such as shown in the cross-sectional view of FIG. 7. That is, the first end 70 of the sleeve may be positioned at an end of the flow line 206 with the second end 68 downstream therefrom.

The sleeve may include a cylindrical reinforcement insert 80. The reinforcement insert 80 may be positioned at least partially within the sleeve 60 and proximate to the first end 70 thereof, such as within the radially extending rim 82.

The sleeve 60 may also include a second reinforcement insert positioned proximate to the second end 68 thereof, such as in the region 73 shown in FIG. 10. Such an insert would be useful in the event of backflow within the flow line. That is, should the direction of fluid flow 102 be reversed, the second end 68 of the sleeve 60 and the region 73 proximate thereto could roll inward and/or allow fluid into the space between the sleeve 60 and the inner wall of the flow line 206, thus obstructing fluid flow.

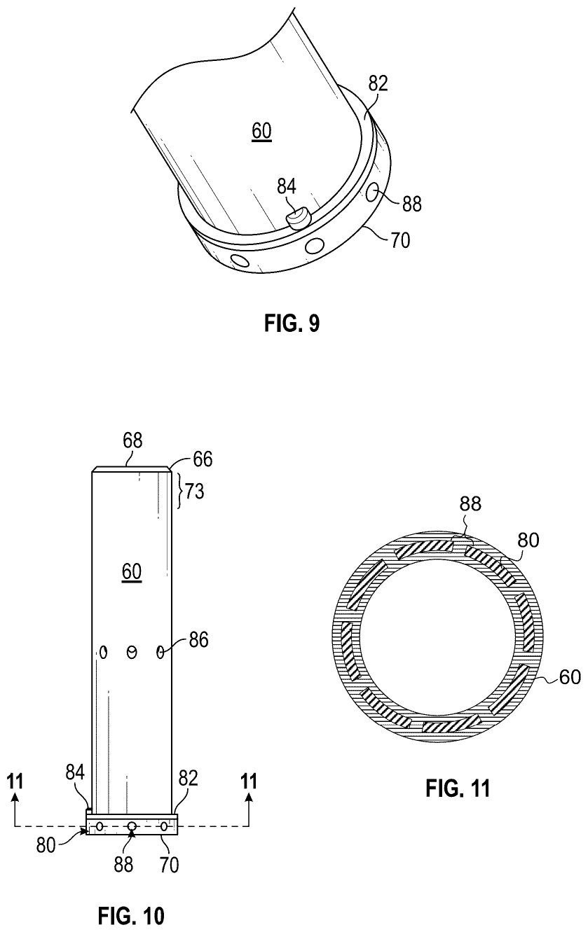

The reinforcement insert 80 may be completely encased within the sleeve 60, such as shown in FIG. 11, which is a cross-sectional view taken along line 11-11 of FIG. 10. Alternatively, an outer circumference of the reinforcement insert 80 may be exposed while the remainder is encased within the sleeve 60, such as shown FIGS. 9 and 10 and the cross-sectional view of FIG. 7. In this latter case, when the sleeve 60 is positioned within a flow line 206, the outer circumference of the reinforcement insert 80 will be in contact with an inner wall of the flow line 206. When included, the second reinforcement insert may be completely encased within the sleeve 60, or an outer circumference thereof may be exposed while the remainder is encased within the sleeve 60.

The reinforcement insert 80 may comprise at least three apertures evenly spaced circumferentially about a cylindrical wall thereof. For example, as shown in FIGS. 9 and 10, the reinforcement insert 80 may include at least three apertures 88. A second reinforcement insert, when included, could also include at least three apertures evenly spaced circumferentially about a cylindrical wall thereof. When forming the wear liner, the material of the sleeve 60, generally a polymeric material, will flow into the apertures of the reinforcement insert(s) to secure the insert(s) within the sleeve. Exemplary polymeric materials useful in forming the sleeve 60 are those indicated above for sleeve 16. The reinforcement insert(s) are composed of a stiffer material than the material of the sleeve 60. Exemplary materials useful in forming the reinforcement insert(s) are those indicated above for sleeve 16.

As shown in FIGS. 7 and 10, the sleeve 60 may comprise at least one radial aperture 86 configured to align with air throttle ports 208 of the flow line 206. The sleeve 60 may also comprise a clocking feature (protrusion 84) to provide alignment of the at least one aperture 86 with the air throttle ports 208 of the flow line 206 when the wear liner is accepted within the flow line. According to aspects, and with reference to FIGS. 10 and 11, the sleeve 60 may include 3 or more or more apertures (86, 88; eight are shown in the figures) that align with aur throttle ports 208 on the flow line 206. An exemplary clocking feature includes the protrusion 84 extending radially outward from an outer circumference of the sleeve 60 and positioned adjacent to the radially extending rim 82 of thereof (see FIGS. 9 and 10).

A wear liner assembly may include the wear liner of FIGS. 6-11, and a nozzle 62. The nozzle generally includes a longitudinal bore with a first region 74 having a first diameter sized and configured to provide attachment over an outer circumference of the flow line 206, a second region 76 having at least a second diameter equal to an internal diameter of a second end 68 of the sleeve 60 of the wear liner, and a rim 64 defining the junction between the first and second regions (i.e., also referred to herein as a transition point).

With specific reference to FIG. 8, which shows an enlarged portion A of FIG. 7, the nozzle 62 may have a first internal diameter defined in part by a wall thickness B of the first region 74 of the nozzle. The flow line 206 may be received within the bore of the first region 74 and secured therein using any connection means known in the art, such as one or more nozzle clamps 203 secured around an outer circumference of the nozzle 63. As shown in FIG. 8, the flow line 206 may include teeth 212 that further secure the line within the nozzle 62.

Of note, the wall thickness (A) of the second region of the nozzle is greater than the wall thickness (B) of the first region of the nozzle. This provides the smooth inner bore of the sleeve through the nozzle. The smaller thickness of the first region also acts as a safety feature. Should large matter pass through the flow line 206 into the nozzle region, the thinner layer of material (B) in the first region of the nozzle may stretch and become even thinner so that the nozzle clamp 203 may not hold the nozzle 62 onto the flow line 206, thus allowing the nozzle to become removed from the flow line. In this case, any failure of the system would be in a direction away from the operator of the flow lines (e.g., person using the flow line comprising the nozzle to apply high pressure concrete such as shotcrete). A similar design of the walls of the nozzle is shown in FIG. 13, wherein the region under the nozzle clamp 203 is thinner than the region “e” at the transition point. Prior art designs do not include this design configuration and risk failure modes that place the operator in danger should the pressures in the flow line exceed sustainable levels or should the flow line burst near the operator's grip on the flow line.

The nozzle 62 may be pushed over the flow line 206 until an end of the flow line rests against the inner rim 64 of the nozzle 62. When the wear liner is received within an inner bore of the flow line 206, the second end 68 of the sleeve 60 may also rest against the inner rim 64 of the nozzle 62. A depth of the rim 64 may substantially match a thickness of the flow line 206 and sleeve 60 of the wear liner so that the second end of the wear liner and the nozzle 62, when attached to the flow line 206, cooperate to form a substantially smooth inner bore of the wear liner assembly (i.e., inner wall of sleeve 60 will be congruent with the inner wall 72 of the nozzle). Prior art nozzles do not include this inner rim, and thus fluid exiting the flow line 206 into the nozzle experience a rapid change in bore diameter, which can lead to eddy currents within the flow line. Such currents can erode the region surrounding the end of the flow line. The nozzle 62 disclosed herein specifically addresses this issue.

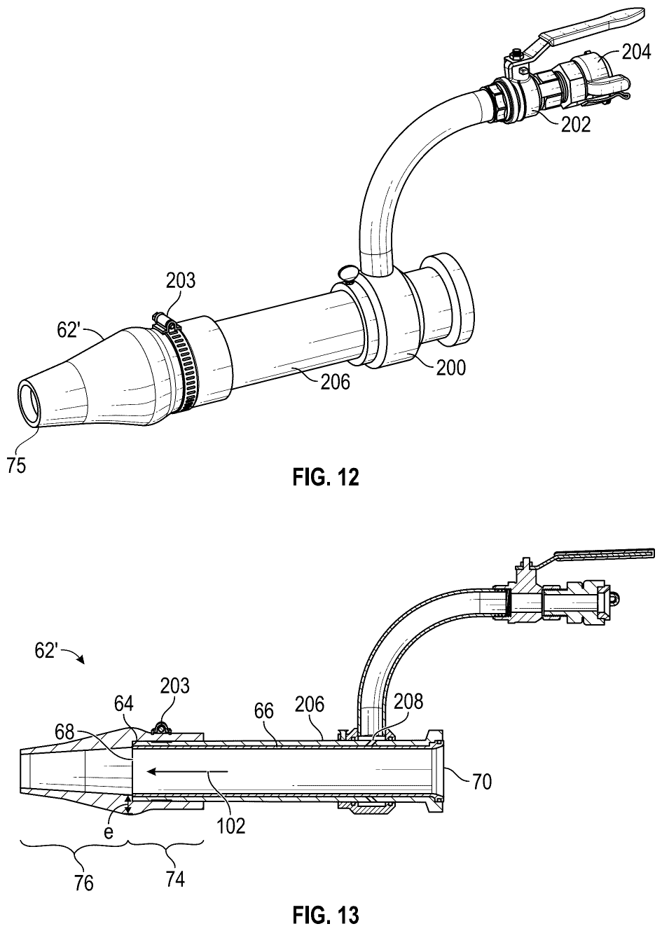

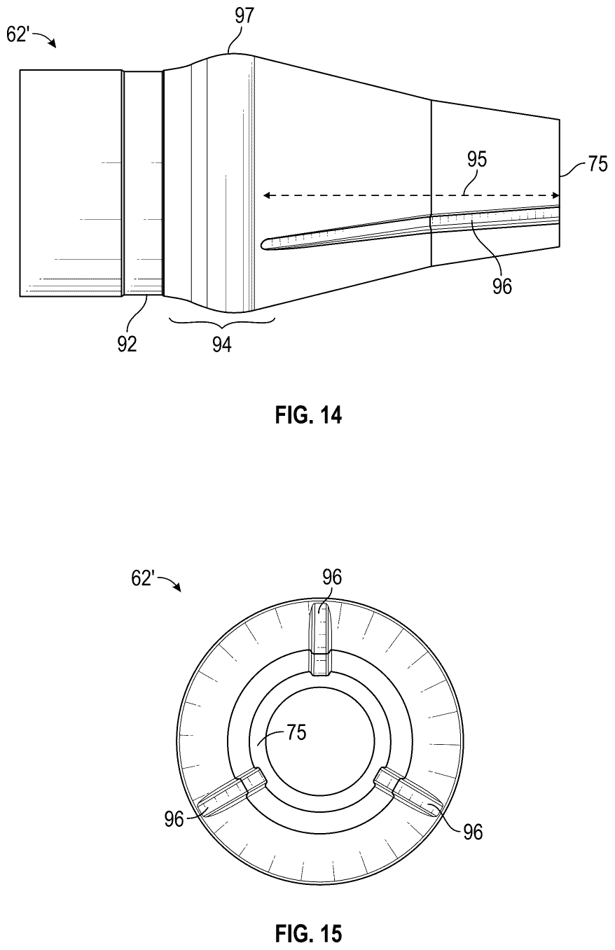

With reference to FIGS. 12 and 13, another implementation of the nozzle 62′ is shown. Of note, the nozzle 62′ includes a longitudinal bore with a first region 74 having a first diameter sized and configured to provide attachment over an outer circumference of the flow line 206, a second region 76 having at least a second diameter equal to an internal diameter of a second end 68 of the sleeve 60 of the wear liner, and a rim 64 defining the junction between the first and second regions (i.e., transition point; see 97 of FIG. 14). However, in this implementation, the exterior profile of the nozzle 62′ includes a bulge (i.e., nozzle bulge; see 94 of FIG. 14) over the region above the rim 64. The bulge extends radially outward substantially above the rim 64 such that a thickest region (‘e’) of the wall of the nozzle 62′ is at the transition point or proximate to the transition point. The wall thickness then decreases from the transition point toward the second end of the nozzle (outlet end 75), such that the thinnest region of the wall of the nozzle 62′ is at the second end of the nozzle or proximate to the second end of the nozzle. An indented region 92 may be included to provide secure attachment of a hose clamp or other means to securely connect the nozzle to the flow line.

This alternate implementation of the nozzle 62′ may address the stresses at discharge from the flow line 206 and nozzle (i.e., at the second end 75), such as when used for high pressure cement applications. As shown, the nozzle 62′ is generally configured to restrict expansion at the outlet end of the flow line 206, i.e., at the region of greatest thickness 94 of the nozzle 62′, while allowing expansion of the nozzle more easily towards the discharge (outlet end 75; i.e., wall thickness decreases from the transition point 97 toward the outlet end 75 of the nozzle). The thinner region at the outlet end 75 of the nozzle 62′ reduces the hoop stress−hoop stress being (radius×pressure)/thickness−such that larger materials may be passed from the nozzle without causing the nozzle to breakdown (crack, explode toward the operator). Further, as previously mentioned, the region under the nozzle clamp is thinner than the region “e” at the transition point such that stress on the nozzle may cause the material of the nozzle to stretch and further thin out, thus allowing the nozzle to disconnect from the flow line 206 away from the operator.

Alternative to reducing the wall thickness, or additionally, the material of the nozzle 62′ may change toward the outlet end 75 thereof, such as by decreasing in hardness or inclusion of expansion slots that have varying depths or widths to allow regions for the nozzle to expand radially (see below and FIGS. 14 and 15).

Such a design may aid in passage of large, unexpected rocks or debris through the flow line 206, such as may occur, for example, when cement is pumped through the flow line. Normal operating pressure at the nozzle when used in such applications is about 80-120 psi. When debris comes through the flow line, the operating pressure can rise to 1200 psi (line pressure potential). Prior art nozzles tend to balloon in the discharge region (e.g., second region 76 of the nozzles 62, 62′) and may burst under such high pressures. When used in high pressure cement application, the operator holds the flow line near the nozzle. Thus, such prior art nozzles pose risks for the operator as they have a tendency to burst next to the operator's hand.

To provide further relief of pressure within the inner bore of the nozzle 62′, some implementations may include slots 96 in the bulged region 94 that extend toward the outlet end 75 of the nozzle, such as shown in FIGS. 14 and 15. These slots create areas for the polymer of the nozzle to stretch to relieve the internal pressure and allow passage of larger objects such as rocks and/or debris that is larger than the current bore diameter.

For example, the nozzle may include one or more slots 96 in the outer profile that extend radially inward, such as radially inward by about 10% of the wall thickness, or 20% of the thickness, or 30% of the thickness, or 40% of the thickness, or 50% of the thickness of the wall of the nozzle. The slots 96 may extend longitudinally from the transition point 97 toward the second end 75 of the nozzle 62′. The slots 96 may extend longitudinally from the transition point 97 to the second end 75 of the nozzle 62′ or to any position therebetween, such as to a point that is at least 90% of a longitudinal distance from the transition point 97 to the second end of the nozzle 75 (e.g., distance 95), or at least 80%, or 70%, or 60%, or 50%, etc.

The slots 96 may be evenly spaced about the outer circumference of the nozzle, such as the three slots shown in FIG. 15. Alternatively, the slots may be positioned about the outer circumference of the nozzle in any pattern useful to achieve stretch of the nozzle that reduces the internal pressure and/or allows passage of larger objects and debris.

The present disclosure also provides a wear liner assembly comprising the wear liner (i.e., at least sleeve 60) as shown in FIGS. 7 and 13, and any of the nozzles described herein (e.g., 62, 62′) formed as a unitary construction. For example, an outlet end 68 of the sleeve 60 may be contiguous with the rim 64 of the nozzle (62 or 62′). As such, the wear liner assembly may be positionable on the fluid line 206 by sliding an end of the fluid line into the slot formed between the outer surface of the wear liner and the inner surface of the first end of the nozzle.

The technologies described in the present disclosure include wear liners, wear liner assemblies comprising a wear liner seal and/or a nozzle, and nozzles, all useful to decrease erosion and/or corrosion in flow lines from particulates and/or irregular flow patterns, and in certain configurations, also useful to reduce the risk of harm to an operator of a fluid line, such as high-pressure fluid lines used to expel particulate laden fluids. These wear liners may be formed of any durable, erosion resistant material, such as filled or unfilled polymers or even metals. In certain preferred configurations, a sleeve of the wear liners is formed of a durable, high durometer polyurethane. Additional components may be included with the wear liners to form wear liner assemblies. Moreover, certain components may be provided separately, e.g., any of the nozzles disclosed herein.

According to aspects, the disclosure provides a wear liner generally configured to be positionable within a bore of a flow line, wherein the wear liner comprises a sleeve having a longitudinal bore therethrough and a radially extending rim at a first end thereof. The wear liner may include one or more reinforcement inserts or alternative structural members to support the softer abrasion resistance material(s) of the sleeve. The reinforcement inserts or alternative structural members may be fully encased within the sleeve, or partially encased within the sleeve. The reinforcement inserts may be positioned radially within the wear liner or may be positioned along a longitudinal extent of the wear liner. Additionally, or alternatively, the sleeve of the wear liner may be adhered/bonded directly to the flow line.

The sleeve of the wear liner may be composed of a hard or filled elastomer, a metal, or other structural material useful to carry the thrust, drag, and pressure loads of the high-pressure flow line and/or provide anti-extrusion for sealing of the sleeve and/or liner seal at positions within the flow line, e.g., joints. For example, the sleeve may be formed of a polymeric or elastomeric material comprising an additive such as glass, ceramic, and/or carbide that improves the durability and thus the load carrying capacity of the wear liner. The sleeve may be composed of a metal or other durable polymeric material. Alternatively, when one or more reinforcement inserts are included in the sleeve, the sleeve may be composed of a flexible or elastomeric material and the reinforcement insert(s) may be composed of a metal, durable polymeric material, or any ridged member for reinforcement. Alternative to reinforcement inserts and/or filled polymers or elastomers, the sleeve may be bonded or adhered to the inner bore of the flow line.

The sleeve may be formed of a metal, or a filled or unfilled elastomeric polymer having a durometer of 50 A to 100 A or 10 D to 70 D, or even 80 D (i.e., having a durometer of at least 50 A or 10 D and not more than 100 A or 80 D). When the sleeve is formed of a filled or unfilled elastomeric polymer, the wear liner may include reinforcement insert(s) within the sleeve, such as reinforcement inserts composed of a metal or a non-elastomeric polymer having a durometer of at least 70 D, such as 70 D to 100 D. In certain configurations, the sleeve may be metal of may be formed of a polymer having a durometer of 60 D to 90 D, and thus may not include reinforcement insert(s).

The wear liner may be included as part of a wear liner assembly. According to a first embodiment, the wear liner assembly may comprise a wear liner configured to be positionable within a bore of a flow line and comprising a sleeve having a longitudinal bore therethrough and a radially extending rim at a first end thereof. The wear liner may include one or more circumferential reinforcement inserts to support the softer abrasion resistance material(s) of the sleeve. The reinforcement inserts may be fully encased within the sleeve, or partially encased within the sleeve such that an outward facing surface of the reinforcement insert(s) is exposed and may contact an inner surface of the flow line. Additionally, or alternatively, the sleeve of the wear liner may be adhered/bonded directly to the flow line.

The wear liner assembly is positionable within a bore of a flow line and includes a wear liner as described hereinabove. The wear liner assembly further includes a liner seal composed of an elastomeric polymer and positionable on the top side of the radially extending rim of the sleeve of the wear liner, wherein a bottom side of the seal is configured to interact with a lip on a top side of the radially extending rim of the sleeve to secure the seal to the sleeve. The wear liner assembly further includes a retaining ring secured, or alternatively, positionable on a top side of the liner seal adjacent an outer circumference thereof, such as within a circumferential gap on the top side of the liner seal. The retaining ring may comprise a metal or non-elastomeric polymer, such as a polymer having a durometer of 60 D or greater, such as 70 D to 90 D. The sleeve and liner seal cooperate to form a substantially smooth inner bore of the wear liner assembly.

When included, a first reinforcement insert may be positioned adjacent the first end of the sleeve and at least partially encased therein. This first reinforcement insert may include a side wall having a top rim that extends radially therefrom, wherein the top rim and side wall of the first reinforcement insert are sized and configured to fit within the radially extending rim and first end of the sleeve, respectively. The sleeve may also include one or more additional reinforcement insert(s), such as a reinforcement insert positioned proximate to a second end of the sleeve and at least partially encased therein. The first and/or additional reinforcement insert(s) may be completely encased within the sleeve, or an outer circumference thereof may be exposed while the remainder is encased within the sleeve such that when the sleeve is positioned within a flow line, the outer circumference of the insert is in contact with an inner wall of the flow line.

The first and/or additional reinforcement insert(s) may comprise at least three apertures evenly spaced about a circumference thereof. For example, the first reinforcement insert may include at least three apertures in each of the top rim and side wall, and the second reinforcement insert may include at least three apertures.

As described, the first and/or additional reinforcement insert may be formed to have a shape substantially coincident with at least a portion of the sleeve. For example, when the sleeve is cylindrical or conical, the reinforcement insert(s) may also be cylindrical or conical, respectively, and may be included at one or more locations along a longitudinal axis of the sleeve, i.e., each insert may have an axial length that is a fraction of the longitudinal extent of the sleeve. Alternatively, the reinforcement inserts may be non-cylindrical and may have a longitudinal length greater than a width, such as rectangular inserts placed within a wall of the sleeve along at least a portion of the longitudinal length thereof (e.g., top end to bottom end of the sleeve, or along any portion thereof). For example, the wear liner may include two or more reinforcement inserts each having a longitudinal body and a top rim that extends radially therefrom, wherein the top rim is sized and configured to fit within the radially extending rim of the sleeve, and the longitudinal body is sized and configured to fit along a longitudinal extent of the sleeve, extending from the top rim toward the second end thereof.

The wear liner assembly may comprise an outer profile configured to provide a snug fit between at least the sleeve and an inner bore of the flow line when the sleeve is accepted therein. For example, the inner bore of the flow line may have a funnel shaped opening, and the sleeve may have a funnel shaped top portion, i.e., conical, and a cylindrical bottom portion. As such, a first reinforcement insert may have a conical shaped side wall and the second reinforcement insert may be cylindrical. Alternatively, the sleeve may or a straight bore with a ledge or other geometry to restrict the axial movements of the liner therein, wherein the liner may include ledges or geometry complementary to the inner bore of the flow line.

A region of the sleeve proximate the second end may taper to provide a reduced sleeve thickness at the second end thereof. Moreover, an outermost edge of the rim of the sleeve may be sized and configured to fit within a gap on an inner surface of the flow line in which it is to be positioned, thus securing the sleeve within the flow line.

The present disclosure also provides a wear liner and wear liner assembly according to a second embodiment. The wear liner includes a sleeve having a longitudinal bore therethrough and a first end having a radially extending rim. The wear liner is generally configured to be fully received within a bore of a flow line with the radially extending rim sized and configured to be snugly accepted by a region of the flow line having an expanded diameter or an attachment point, such as one or more grooves in the flow line providing space for correspondingly dimensioned protrusions, a ledge, or the like.

The wear liner may comprise at least one radial aperture configured to align with air throttle ports of the flow line and a protrusion extending radially outward from an outer circumference of the wear liner, wherein the protrusion is configured to provide alignment of the at least one aperture with the air throttle ports of the flow line when the wear liner is accepted within the flow line.

The sleeve may include one or more reinforcement inserts at least partially encased therein. For example, a first reinforcement insert may be cylindrical and may be positioned within the radially extending rim. The wear liner may include additional cylindrical reinforcement inserts, such as an insert positioned proximate to a second end of the sleeve. The reinforcement insert(s) may be completely encased within the sleeve, or an outer circumference of the reinforcement insert(s) may be exposed while the remainder is encased within the sleeve such that when the sleeve is positioned within a flow line, an outer circumference of the reinforcement insert(s) may be in contact with an inner wall of the flow line. The reinforcement insert(s) may comprise at least three apertures evenly spaced about a circumference thereof.

As described, the reinforcement insert may be formed to have a shape substantially coincident with at least a portion of the sleeve, e.g., cylindrical. Alternatively, the reinforcement inserts may be non-cylindrical and may have a longitudinal length greater than a width, such as rectangular inserts placed within a wall of the sleeve along at least a portion of the longitudinal length thereof (e.g., top end to bottom end of the sleeve, or along any portion thereof). For example, the wear liner may include two or more reinforcement inserts each having a longitudinal body and a top rim that extends radially therefrom, wherein the top rim is sized and configured to fit within the radially extending rim of the sleeve, and the longitudinal body is sized and configured to fit along a longitudinal extent of the sleeve, extending from the top rim toward the second end thereof.

Alternative to reinforcement inserts, or in addition thereto, the sleeve of the wear liner of the second embodiment may be bonded or adhered to the inner bore of the flow line.

The sleeve of the wear liner may be composed of a hard or filled elastomer (e.g., glass or carbide filled), a metal, or other structural material useful to carry the thrust, drag, and pressure loads of the high-pressure flow line and/or provide anti-extrusion and/or sealing of the sleeve at positions within the flow line, e.g., joints. For example, the sleeve may be composed of a metal or other durable polymeric material. Alternatively, when one or more reinforcement inserts are included in the sleeve, the sleeve may be composed of a flexible or elastomeric material and the reinforcement insert(s) may be composed of a metal or durable polymeric material. For example, the sleeve may be formed of a filled or unfilled elastomeric polymer having a durometer of 50 A to 100 A or 10 D to 70 D, or even 80 D (i.e., having a durometer of at least 50 A or 10 D and not more than 100 A or 80 D), and the reinforcement insert may comprises a metal or a non-elastomeric polymer having a durometer of at least 70 D, such as 70 D to 100 D. The sleeve may have a durometer of 60 D to 90 D, and thus may not include reinforcement inserts.

A wear liner assembly may include the wear liner of the second embodiment and a nozzle having first and second ends and a longitudinal bore therebetween. A first region of the longitudinal bore of the nozzle extending from a first end of the nozzle toward a midpoint of the nozzle has a first inner diameter that is sized and configured to provide attachment over an outer circumference of the flow line. A second region of the longitudinal bore of the nozzle extending from an end of the first region to a second end of the nozzle has a second inner diameter that is may be smaller than the first inner diameter but equal to, or substantially equal to, an internal diameter of a second end of the wear liner. The wear liner is configured to be received within an inner bore of the flow line and may be sized so that ends of the wear liner are substantially coincident with a first and second end of the flow line. The nozzle is configured to receive the second end of the flow line within the first region of the longitudinal bore. As such, the wear liner and the first region the nozzle, when attached to the flow line, cooperate to form a substantially smooth inner bore of the wear liner assembly.

The present disclosure also provides a wear liner assembly comprising the wear liner of the second embodiment and a nozzle having a longitudinal bore with a first and second region as described hereinabove, i.e., a second region having second inner diameter that is equal to, or substantially equal to, an internal diameter of a second end of the wear liner so that, when attached to the flow line, the wear liner and nozzle cooperate to form a substantially smooth inner bore of the wear liner assembly. However, a thickness of the nozzle may be increased in a specific region, such as having the greatest thickness extending radially at a position between the first region and second region of the longitudinal bore.

The nozzle may be configured to restrict expansion at the inlet, i.e., along the region of greatest thickness, while allowing increases in the inner diameter more easily towards the discharge. As such, a thickness of the nozzle may be reduced toward a second end of the nozzle distal from the connection to the flow line. Alternatively, or additionally, the material of the nozzle may change toward the second end thereof, such as by decreasing in hardness or inclusion of expansion slots (i.e., one or more slots that extend longitudinally along at least a portion of the outer surface of the nozzle). The nozzle may be composed of a filled or unfilled polymer or elastomeric polymer having a durometer of 50 A to 100 A or 10 D to 70 D, or even 80 D (i.e., having a durometer of at least 50 A or 10 D and not more than 100 A or 80 D).

The present disclosure also provides a wear liner assembly comprising the wear liner of the second embodiment and any of the nozzles described herein formed as a unitary construction. For example, the second end of the wear liner may be connected and contiguous with an inner region of the nozzles, such as at the transition point. As such, the wear liner assembly may be positionable on the fluid line by sliding an end of the fluid line into the slot formed between the outer surface of the wear liner and the inner surface of the first end of the nozzle. An inner bore of the wear liner assembly of unitary construction is smooth (i.e., no ledges or the like on the inner bore).

The present disclosure also provides use of any of the nozzles described herein in the absence of a wear liner. The disclosed nozzles may be attached to the flow line, such as over an outer circumference of the flow line, and secured thereon with a strap, a hose clamp or other means to securely connect the nozzle to the flow line.

The inventions detailed in this disclosure are not limited to the specific devices, methods, processes, elements, or parameters described and/or shown herein and the terminology used herein is for the purpose of describing the various embodiments and is by way of example only and not intended to be limiting of the claimed invention. All patents and other publications identified in this specification are incorporated by reference as though fully set forth herein.

### LISTING OF REFERENCE NUMBERS

10 reinforcement insert of the sleeve 16
10a circumferential side portion of the reinforcement insert 10
10b circumferential top rim of the reinforcement insert 10
12 liner seal
13 outer rim of the sleeve 16
14 retaining ring
16 wear liner (sleeve)—first embodiment
18 bottom end of the sleeve 16
20 lip on the sleeve 16
22 second reinforcement insert of sleeve 16
23 region that tapers adjacent bottom end of the sleeve 16
24 top end of the sleeve 16
25 point of change of the inner diameter of the sleeve 16
30a apertures along the side portion 10a of the insert 10
30b apertures along the top rim 10b of the insert 10
60 wear liner (sleeve)—second embodiment 62, 62′ nozzle
64 rim on inner wall 72 of the nozzle 62
66 bevel at bottom end 68 of wear liner 60
68 second (bottom) end of the wear liner 60
70 first end of the wear liner 60
71 point of change of the inner diameter of the nozzle through bore
72 inner wall of nozzle through bore
73 possible position of a bottom reinforcement insert of wear liner 60
74 first region of the nozzle 60
75 second end of the nozzle 60
76 second region of the nozzle 60
80 reinforcement insert of wear liner 60
82 radially extending rim (lip) of the wear liner 60
84 clocking feature (protrusion) of wear liner 60
86 air throttle holes (radially positioned apertures) of wear liner 60
88 apertures in wear liner 60
92 attachment region
94 nozzle bulge
95 length of nozzle indent
96 nozzle indent (slot)
97 transition point
100 flow line
102 direction of fluid flow in flow line 100
200 air mixing housing with air throttle ports (208)
202 air valve
203 nozzle clamp
204 inlet for compressed air
206 flow line
208 air throttle ports of the flow line 206
210 gaskets
212 teeth at end of flow line 206
A thickness of region 76 of the nozzle
B thickness of region 74 of the nozzle
e thickest region of the nozzle 62′

What is claimed is:

1. A wear liner positionable within a bore of a flow line, the wear liner comprising:
a sleeve formed of a flexible polymer and having a longitudinal bore therethrough, the sleeve comprising a first end having a radially extending rim and a second end opposite the first end;
a reinforcement insert formed of a metal or non-elastomeric polymer, the reinforcement insert comprising atop rim extending radially from a circumferential side wall, wherein the top rim and side wall of the reinforcement insert are sized and configured to fit within the radially extending rim and first end of the sleeve, respectively,
wherein the reinforcement insert is at least partially encased within the sleeve.

2. The liner of claim 1, wherein the reinforcement insert comprises at least three apertures in each of the top rim and side wall.

3. The liner of claim 1, further comprising:
a second reinforcement insert positioned proximate to the second end of the sleeve and at least partially encased therein.

4. The liner of claim 3, wherein the sleeve is formed of a filled or unfilled elastomeric polymer having a durometer of at least 50 A or 10 D and not more than 100 A or 80 D, and wherein each of the first and second reinforcement inserts individually comprise a metal or a non-elastomeric polymer having a durometer of at least 70 D.

5. The liner of claim 3, wherein the second reinforcement insert comprises at least three apertures spaced about a circumference thereof.

6. The liner of claim 1, wherein a region of the sleeve proximate the second end tapers to provide a reduced sleeve thickness at the second end thereof.

7. The liner of claim 1, wherein a top side of the rim of the sleeve comprises a lip, and the liner further comprises:
a liner seal composed of an elastomeric material and positionable on the top side of the rim of the sleeve, the liner seal having:
a bottom side configured to interact with the lip of the sleeve to secure the liner seal to the sleeve, and
a retaining ring secured on a top side of the liner seal along an outer circumference thereof,
wherein the sleeve and liner seal cooperate to form a substantially smooth inner bore of the liner assembly.

8. The liner of claim 7, wherein the retaining ring is positioned within a circumferential gap in the top side of the liner seal, wherein the retaining ring comprises a metal or non-elastomeric polymer.

9. The liner of claim 1, wherein an outermost edge of the rim of the sleeve is sized and configured to fit within a gap on an inner surface of the flow line in which it is to be positioned.

10. A wear liner assembly positionable within a bore of a flow line, the assembly comprising a wear liner, wherein the wear liner comprises:
a sleeve having a longitudinal bore therethrough, the sleeve comprising a first end having a radially extending rim and a second end opposite the first end; and
a first cylindrical reinforcement insert at least partially encased within the radially extending rim,
wherein the sleeve is configured to be fully received within a bore of a flow line with the radially extending rim coincident with an end of the flow line or a region of the flow line having an expanded diameter.

11. The assembly of claim 10, wherein the sleeve comprises at least one radial aperture configured to align with air throttle ports of the flow line.

12. The assembly of claim 11, wherein the sleeve includes a protrusion extending radially outward from an outer circumference thereof, the protrusion configured to provide alignment of the at least one radial aperture of the sleeve with the air throttle ports of the flow line.

13. The assembly of claim 10, wherein the first cylindrical reinforcement insert comprises at least three apertures spaced about a circumference thereof.

14. The assembly of claim 10, further comprising:
a second cylindrical reinforcement insert at least partially encased within the sleeve and positioned proximate to the second end of the sleeve.

15. The assembly of claim 14, wherein the second cylindrical reinforcement insert comprises at least three apertures spaced about a circumference thereof.

16. The assembly of claim 14, wherein the sleeve is formed of a filled or unfilled polymer or elastomeric polymer having a durometer of at least 50 A or 10 D and not more than 100 A or 80 D, and wherein each of the first and second cylindrical reinforcement inserts individually comprise a metal or a non-elastomeric polymer having a durometer of at least 70 D.

17. The assembly of claim 10, comprising:
a nozzle having a longitudinal bore therethrough, the longitudinal bore having a first region extending from a first end of the nozzle to a transition point, and a second region extending from the transition point to a second end of the nozzle, wherein the first region of the nozzle has a first internal diameter sized and configured to provide attachment over an outer circumference of the flow line, and the second region of the nozzle has a second internal diameter smaller than the first internal diameter and equal to an internal diameter of the second end of the sleeve,
wherein the second end of the sleeve and the nozzle, when attached to the flow line, cooperate to form a substantially smooth inner bore of the wear liner assembly.

18. The assembly of claim 17, wherein the nozzle has an outer profile that extends radially outward at the transition point between the first region and the second region such that a wall of the nozzle is thickest proximate the transition point and thinnest at the second end thereof.

19. The assembly of claim 18, wherein the nozzle includes one or more slots in the outer profile that extend longitudinally from the transition point toward the second end of the nozzle, wherein each of the one or more slots extends radially inward.

20. The assembly of claim 17, wherein the nozzle is composed of a filled or unfilled polymer or elastomeric polymer having a durometer of at least 50 A or 10 D and not more than 100 A or 70 D.

21. A nozzle having:
a longitudinal bore therethrough, the longitudinal bore having a first region extending from a first end of the nozzle to a transition point, and a second region extending from the transition point to a second end of the nozzle, wherein the first region of the longitudinal bore has a first internal diameter sized and configured to provide attachment over an outer circumference of a flow line, and the second region of the longitudinal bore has a second internal diameter smaller than the first internal diameter, wherein the second internal diameter is configured to be equal to an internal diameter of the flow line to form a substantially smooth inner bore when the nozzle is attached to the flow line, and
an outer profile that extends radially outward at the transition point such that a wall of the nozzle is thickest proximate the transition point and thinnest at the second end thereof.

22. The nozzle of claim 21, comprising one or more slots in the outer profile that extend longitudinally from the transition point toward the second end of the nozzle, wherein each of the one or more slots extend radially inward.

23. The nozzle of claim 21, comprising a filled or unfilled polymer or elastomeric polymer having a durometer of at least 50 A or 10 D and not more than 100 A or 60 D.
